(19) United States
(12) Patent Application Publication
(10) Pub. No.: US 2006/0040234 A1
(43) Pub. Date: Feb. 23, 2006

(54) Denture device

(75) Inventor: Alex Posca, Santa Ana, CA (US)

Correspondence Address: TONG & ASSOCIATES, 5850 ANOGA AVENUE, SUITE #400, WOODLAND HILLS, CA, 91367, US

(73) Assignee: Orange County Cosmetic Dental Lab, Inc., Orange, CA (US)

(21) Appl. No.: 10/921,217

(22) Filed: Aug. 17, 2004

(51) Int. Cl. A61C 13/12; A61C 13/00

(52) U.S. Cl. 433/177; 433/167

(57) ABSTRACT

The present invention includes a denture device having a base configured to be positioned on a natural gum and at least partially surround the natural gum, at least one artificial gum attachable to the base, and at least one artificial tooth attached to the artificial gum. The artificial gum preferably includes a retaining portion. When the artificial gum is attached to the base, the retaining portion of the artificial gum preferably abuts to an undercut of a natural tooth to substantially secure the base, the artificial gum, and the artificial tooth to the natural gum.

### CROSS REFERENCE TO RELATED APPLICATIONS

None

### FIELD OF INVENTION

The present invention relates to medical devices, particularly dental devices designed to provide one or more artificial teeth.

### BACKGROUND

Partial dentures are generally devices employed to provide one or more artificial teeth. Partial dentures may be removeable to allow users to regularly clean them. As such, existing partial denture designs may vary in the way they attach to a jaw. For instance, in U.S. Pat. No. 4,661,068, a partial denture utilizes complementary male and female interlocking members. The male member appears to require removal of an enamel of a natural tooth so that a mounting portion can be attached. A connector ball is then attached to the mounting portion, and the connector ball interlocks with the female member of an artificial tooth thereby allowing the artificial tooth to be attached to the natural tooth. At least one problem with this type of partial denture is that the attachment method being employed requires a part of a natural tooth to be removed. It is desirable to have a partial denture that securely attaches to a jaw without employing surgical methods or alteration to the natural tooth.

Another partial denture is disclosed in U.S. Pat. No. 4,764,115, wherein an elastic retainer strip is employed to attach the partial denture to a plurality of natural teeth. The retainer strip is provided in the area of the partial denture that is configured to be positioned proximate to a subject's natural teeth. The elastic retainer strip appears to engage to an area where the existing teeth emerge from the subject's gum area thereby preventing the portion of the partial denture that has the retainer strip from moving vertically. At least one problem with the partial denture in patent number '115 is that the partial denture area distal to the elastic retainer strip, such as the molar area of the partial denture shown in the drawings of patent number '115, may not be securely attached to the subject's jaw. Loose portions of the partial denture disclosed in patent number '115 may irritate the subject's jaw and may allow objects, especially food, to be retained underneath the partial denture. The retained food may cause tooth decay. Additionally, the partial denture in patent number '115 may not allow the subject to effectively chew food because of the lack of secure attachment of the partial denture to the jaw.

Another example of a conventional partial denture is shown in FIG. 1 wherein artificial teeth 102a-d are attached to an artificial gum 104, and the artificial gum 104 is attached to a metal brace 106. The metal brace 106 may have a pair of clasps 108 and 110 that attaches the partial denture, which includes artificial gums 104 and 112 and the artificial teeth 102a-f, to two natural teeth (not shown). With reference to FIG. 2, the clasps 108 and 110 typically engage and grip the sides of the natural teeth thereby securing the partial denture to the natural teeth.

At least one problem with the partial denture shown in FIGS. 1 and 2 is that over time, the clasps can damage the natural teeth. Over time, the clasps can also become loose, and the partial dentures may have to be replaced. Another problem is that objects, such as food, may be retained within the crevices 114 and 116 in between the clasps 108 and 110. Food retained within these crevices 114 and 116 over time may cause tooth decay. Yet another problem the partial denture shown in FIG. 1 is that the clasps may be visible and unattractive to others. The clasps can also cause discomfort to the user. It is desirable to have a partial denture that substantially overcomes the problems associated with existing partial dentures.

### BRIEF DESCRIPTION

The present invention includes a denture device having a base configured to be positioned on a natural gum and at least partially surround the natural gum, at least one artificial gum attachable to the base, and at least one artificial tooth attached to the artificial gum. The artificial gum preferably includes a retaining portion. When the artificial gum is attached to the base, the retaining portion of the artificial gum preferably abuts to an undercut of a natural tooth to substantially secure the base, the artificial gum, and the artificial tooth to the natural gum.

The present invention also includes a method for attaching a denture to a user. The method preferably includes providing a base, the base comprising a natural gum enclosure configured to substantially surround the ridge of the natural gum; providing a male fitting connected to the base, the male fitting being configured to receive and fasten a female fitting connected to an artificial gum; providing an artificial gum, the artificial gum comprising a retaining portion configured to abut to an undercut area of a natural tooth; and allowing the male fitting to engage with the female fitting and the retaining portion to abut to the undercut area of the natural tooth.

The above description sets forth, rather broadly, a summary of certain embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of a sample existing partial denture.

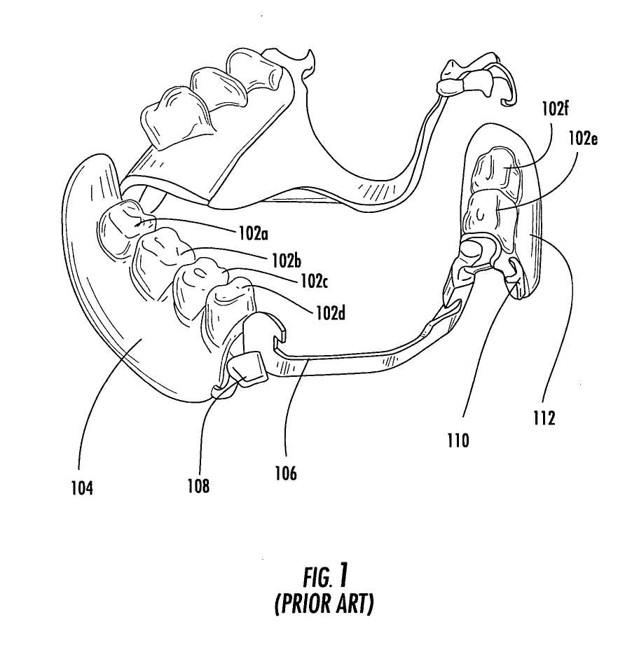

FIG. 2 is substantially a schematic diagram showing the attachment mechanism for the existing partial denture shown in FIG. 1.

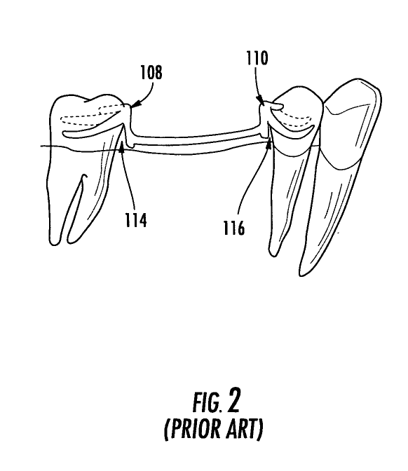

FIG. 3 is substantially a top perspective view of an embodiment of the present invention.

FIG. 4 is substantially a top plan view of the embodiment shown in FIG. 3.

FIG. 5 is substantially a perspective view of an embodiment of an artificial tooth assembly of the present invention.

FIG. 6 is substantially a perspective view of an embodiment of a female fitting for an artificial tooth assembly of the present invention.

FIG. 7 is substantially a side view of the artificial tooth assembly embodiment shown in FIG. 5 further showing the attachment of the female fitting to the artificial gum.

FIG. 8 is substantially a perspective view of an embodiment of a denture of the present invention shown as being attached to a jaw.

FIG. 9 is substantially a front view of the denture embodiment shown in FIG. 8 further showing a method of attaching the denture embodiment to the jaw.

FIG. 10 is substantially a front view of the denture embodiment shown in FIG. 8 further showing a method of detaching the denture embodiment from the jaw.

FIG. 11 is substantially a top perspective of another embodiment of the denture device of the present invention.

FIG. 12 is substantially a rear view of a jaw having an attached denture device embodiment shown in FIG. 11 without the third artificial tooth assembly.

FIG. 13 is substantially a bottom plan view of the denture device embodiment shown in FIG. 11 without the third artificial tooth assembly.

FIG. 14 is substantially a perspective view of the third artificial tooth assembly of the denture device embodiment shown in FIG. 11 further showing the female fitting attached to the artificial gum.

FIG. 15 is substantially a rear view of a jaw having an attached denture device embodiment shown in FIG. 11 with the third artificial tooth assembly.

FIG. 16 is substantially a front view of a jaw having an attached denture device embodiment shown in FIG. 11 with the third artificial tooth assembly.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. As used herein, the term “denture” is used to refer to an artificial replacement for one or more teeth. The term “denture” may refer to a partial denture or a full denture. The term “users” may refer to human beings or animals using the devices or methods of the present invention.

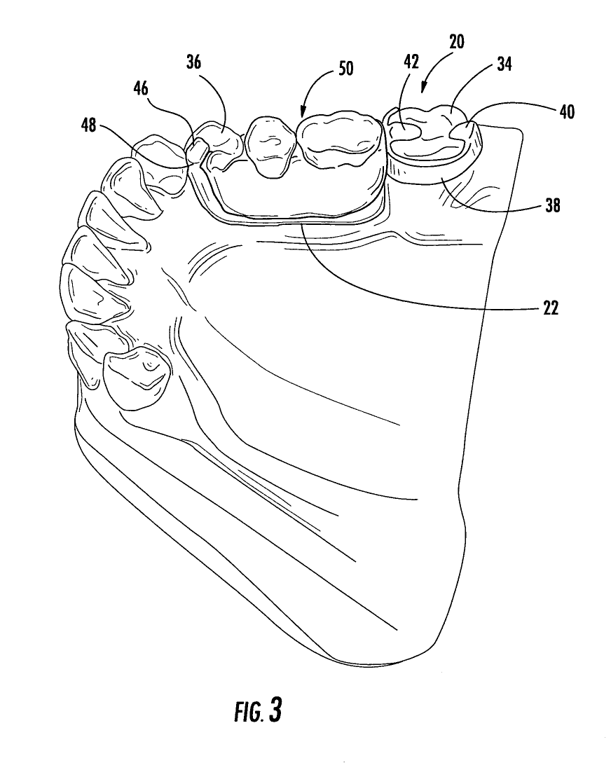

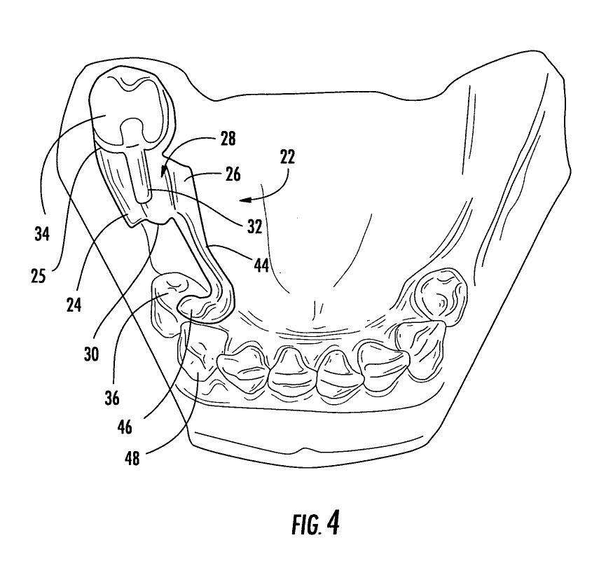

The present invention comprises a denture, generally indicated by reference number 20. Referring to FIG. 3, denture 20 preferably includes a base 22 configured to receive at least one artificial tooth assembly 50. Referring to FIG. 4, base 22 preferably includes opposing slopes 24 and 26. Opposing slopes 24 and 26 preferably meet at an intersection and form a ridge 28 at their intersection. The opposing slopes 24 and 26 and ridge 28 preferably define a substantially U-shaped cross-section (not shown). The bottom of opposing slopes 24 and 26 and ridge 28 is preferably configured to lay on a natural gum 30 and substantially surround the natural gum 30. Opposing slope 24 preferably includes a slope extension 25, which is preferably substantially perpendicular to the ridge 28. Slope extension 25 is preferably configured to abut to a natural tooth 34 to help secure the denture 20 in place. Base 22 preferably further includes a male fitting 32 positioned on top of the ridge 28.

As shown in FIG. 3, denture 20 is an embodiment preferably designed to provide artificial teeth in between lower right second molar tooth 34 and lower right first bicuspid 36. It is to be understood that denture 20 of the present invention may be designed to provide one or more artificial teeth at various places in a mouth, such as upper and lower teeth at both sides the mouth. For instance, the artificial teeth may be in the upper jaw or the mandible and the central, left, or right side of the mouth. The artificial teeth may create a cluster or may individually be positioned in a mouth.

For the embodiment of denture 20 shown in FIG. 3, base 22 of denture 20 preferably further includes a band 38 configured to at least partially surround a side of the lower right second molar tooth 34. The second molar tooth 34 may have a side that has a bottom portion that is narrower than the top portion thereby creating a slight overhang. The area between the narrower bottom portion and the gum may be referred to as an undercut area. Band 38 preferably wraps around the undercut area in a manner wherein when the band 38 is lifted up and away from the second molar tooth 34, a portion of the band 38 abuts to the bottom side of the molar tooth 34. Therefore, the band 38 helps minimize the movements of the base 22.

One end of the band 38 preferably forms a band extension 40, which is preferably configured to sit on the second molar tooth 34. Opposite the position of the band extension 40 on the second molar tooth 34 is preferably a ridge extension 42, which preferably originates from the ridge 28. It can be appreciated that the band 38, the band extension 40, and the ridge extension 42 help minimize movements of the base 22.

With reference to FIG. 4, base 22 preferably further includes a base extension 44, which originates from the slope 26. Base extension 44 is preferably configured to be positioned on a jaw initially substantially parallel to a gum line and gradually increases in slope up to the top of the lower right first bicuspid 36. The end 46 of base extension 44 preferably sits on the top of the bicuspid 36 and is preferably designed to be positioned substantially flush with the bicuspid structure 36 and cuspid structure 48. The end 46 helps retain the denture 20 to its seated position on the gum.

Base 22 is preferably made of a metal alloy, which may include a mixture of cobalt and chromium. Base 22 may be made with other materials known in the art, such as acrylic. Base 22 may further be made by techniques known in the art, such as conventional polymerization techniques, including metal casting.

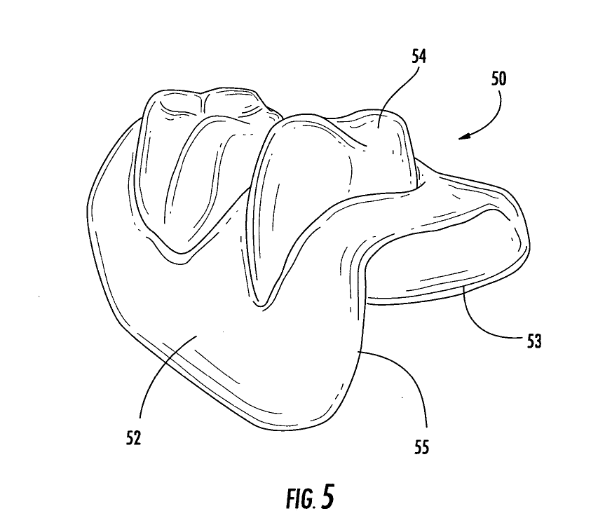

With reference now to FIG. 5, denture 20 of the present invention preferably further includes at least one artificial tooth assembly 50. The artificial tooth assembly 50 preferably includes at least one artificial gum 52 and at least one artificial tooth 54. The artificial tooth is preferably embedded within the artificial gum 52. The artificial gum 52 and the artificial tooth 54 are preferably made of acrylic or other materials known in the art. The artificial tooth assembly 50 may be made by conventional polymerization techniques, such as by lost-wax technique known in the art.

The artificial gum 52 is preferably configured to lay on the natural gum when the artificial tooth assembly 50 is attached to the base 22 that is also laying on the natural gum (FIG. 3). Thus, the artificial gum 52 is configured to cover the natural gum area where it will lay. With continued reference to FIG. 5, the artificial gum 52 preferably includes retaining portions 53 and 55. Retaining portions 53 and 55 are preferably configured to allow the artificial tooth assembly 50 and the base 22 of denture 20 to be securely positioned to a jaw by engaging to the undercut area of a natural tooth.

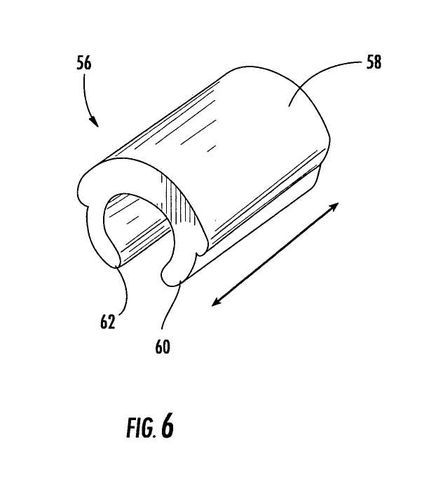

Referring now to FIG. 6, the artificial tooth assembly 50 preferably further includes a female fitting 56. The female fitting 56 preferably has a structure that resembles a tube that is cut in half at the elongate axis of the tube, as indicated by the arrow in FIG. 6. The female fitting 56 may include a semi-cylindrical body 58 and a pair of fingers 60 and 62 extending from the body 58. The pair of fingers 60 and 62 is preferably configured to grasp the male fitting 32 of the base 22 (FIG. 4). The female fitting 56 may be a device commonly referred to as the Hader Bar in the dental device industry and may be obtained from Preat Corporation of Santa Ynez, Calif.

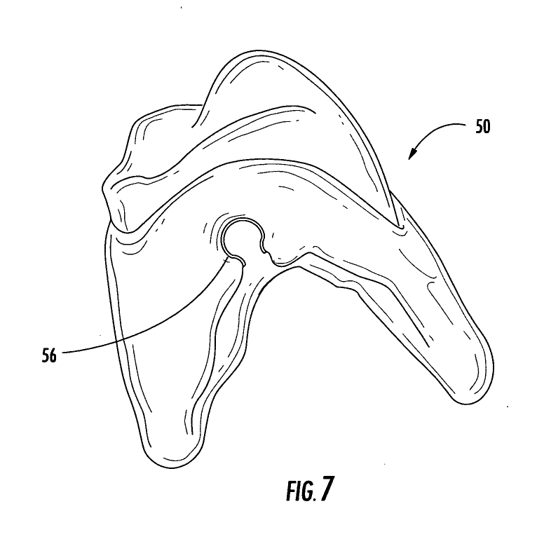

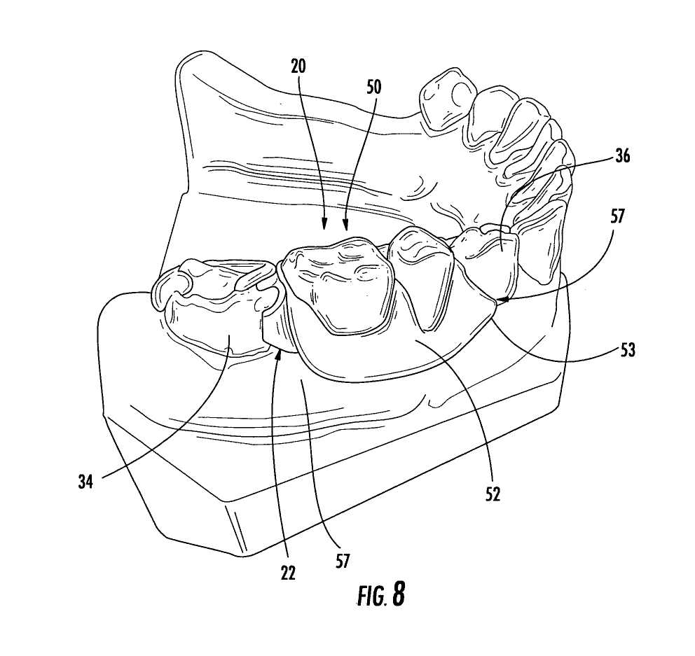

Referring now to FIG. 7, the female fitting 56 is preferably attached to the bottom of the artificial tooth assembly 50 and positioned in a manner that allows the female fitting 56 to unite with the male fitting 32 when the artificial tooth assembly 50 is attached to the base 22 (FIG. 3). Referring to FIG. 8, when the artificial tooth assembly 50 is attached to the base 22, it can be appreciated that the denture 20 forms a substantially continuous wall together with the natural teeth, such as the second molar tooth 34 and the bicuspid 36. The wall may prevent food or other objects from being stuck in between the artificial tooth assembly 50 and the natural teeth 34 and 36. It can also be realized that the present invention provides a denture that has a base that is substantially concealed by artificial gums from a front view. Thus, the present invention, may provide a denture that is more aesthetically pleasing than conventional dentures.

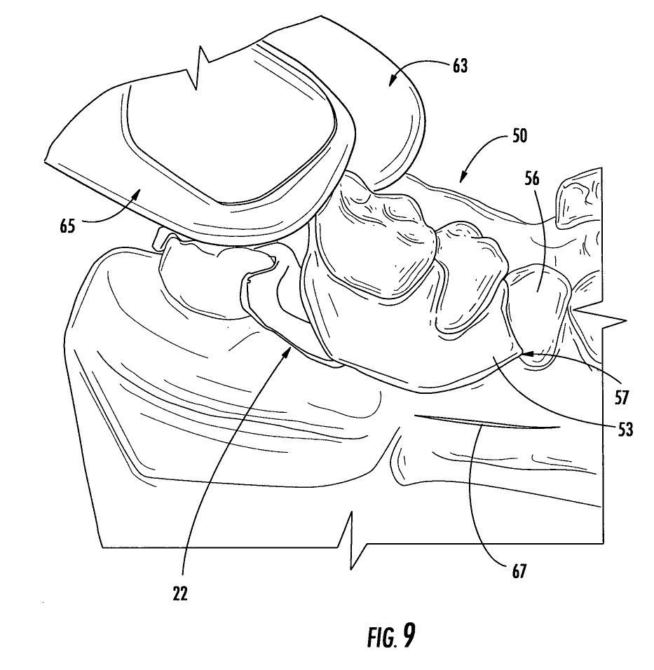

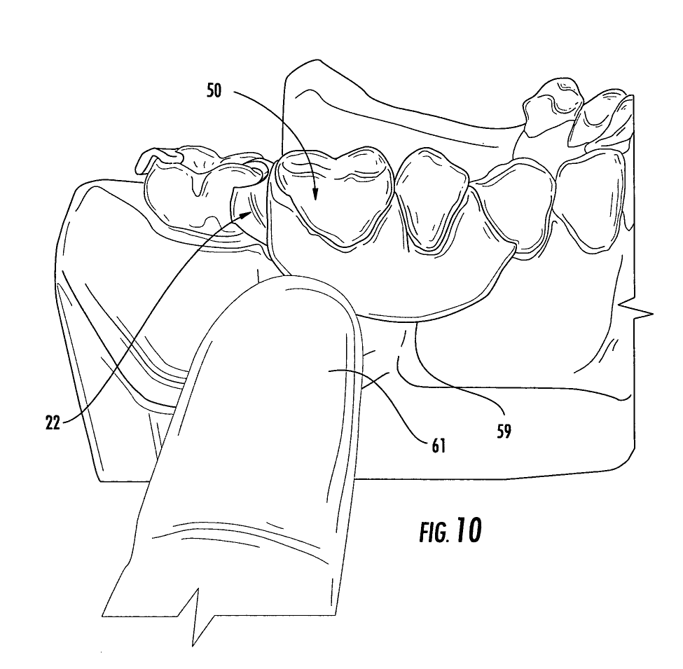

With continued reference to FIG. 8, it is noted that the artificial tooth assembly 50 and the base 22 are secured to the jaw 51 by the retaining portions 53 and 55 of the artificial gum 52. Some portions of the retaining portion 53 and 55 abut to the undercut area 57 of the bicuspid 36 thereby substantially preventing the denture 20 from detaching from the jaw 51, except with the use of sufficient force. Referring now to FIG. 9, to engage the retaining portions 53 and 55 to the undercut area 57 when attaching the artificial tooth assembly 50 to the base 22, the artificial tooth assembly 50 is preferably attached to the base 22 by tilting the artificial tooth assembly 50 at an angle relative to the gum line 67 using fingers 63 and 65, allowing the retaining portions 53 and 55 to contact the bicuspid 36, and applying a downward force preferably onto the portion of the artificial tooth assembly 50 that is opposite the retaining portions 53 and 55. Referring to FIG. 10, to detach the artificial tooth assembly 50 from the base 22, a user preferably uses a finger 61 to lift the bottom portion 59 of the artificial tooth assembly 50 that is distal to the retaining portions 53 and 55 and apply an upward force to the bottom portion 59.

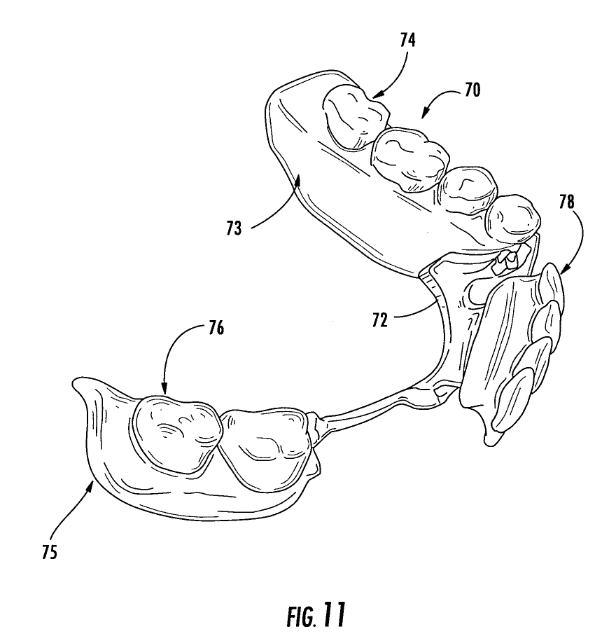

Referring now to FIG. 11, another embodiment of the denture of the present invention is shown and referred to using reference number 70. Denture 70 preferably includes a base 72 preferably of similar material to base 22 discussed above. Denture 70 preferably also includes a first artificial teeth assembly 74 positioned on a first end 73 of denture 70 and a second artificial teeth assembly 76 positioned at the second end 75, which is opposite to the first end 73. The first and second artificial teeth assemblies 74 and 76 are preferably permanently affixed to the base 72.

Denture 70 preferably further includes a removeable third artificial teeth assembly 78. Each assembly 74, 76, and 78 may include an artificial gum and artificial teeth of similar material to artificial gum 52 and artificial teeth 54 discussed above. It is noted that the numbers of artificial teeth, the locations, sizes, and numbers of the artificial teeth assemblies, and the shape of the base may vary, depending on the positions, structures, and numbers of remaining natural teeth of the user. The shape of the base may further vary depending on the natural gum structure.

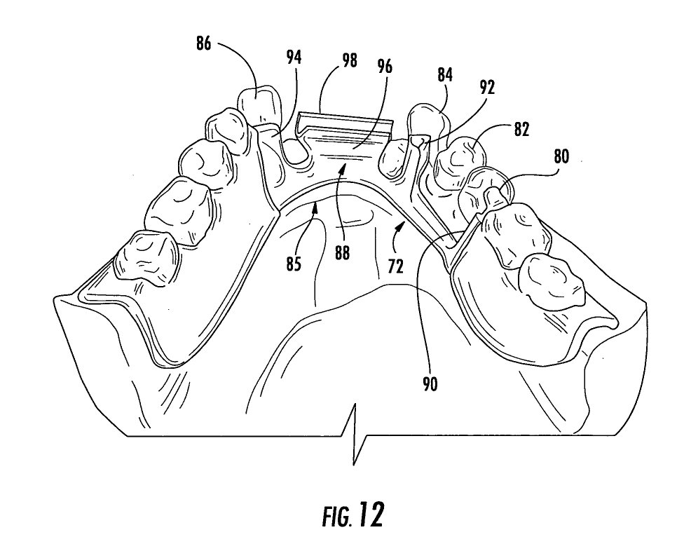

For example, referring now to FIG. 12, the denture embodiment 70 is preferably for use with a jaw that has a left second bicuspid 80, a left first bicuspid 82, and a left cuspid 84, and a right cuspid 86 as remaining natural teeth. The base 72 preferably has a main body 88 that is designed to follow the shape of the front interior gum line 85 of the jaw. Base 72 preferably has a first extension 90 protruding from the main body 88 and abutting the undercut area of the left second bicuspid 80. Base 72 may also have a second extension 92 protruding from the main body 88 and abutting the rear side of the left cuspid 84. Next, base 72 may have a third extension 94 protruding from the main body 88 and abutting the rear side of the right cuspid 86. Base 72 may further have a fourth extension 96 protruding from the main body 96 and abutting the central interior side of the gum. A male fitting 98 is preferably attached at the end of the fourth extension 96, where the third artificial teeth assembly 78 may attach.

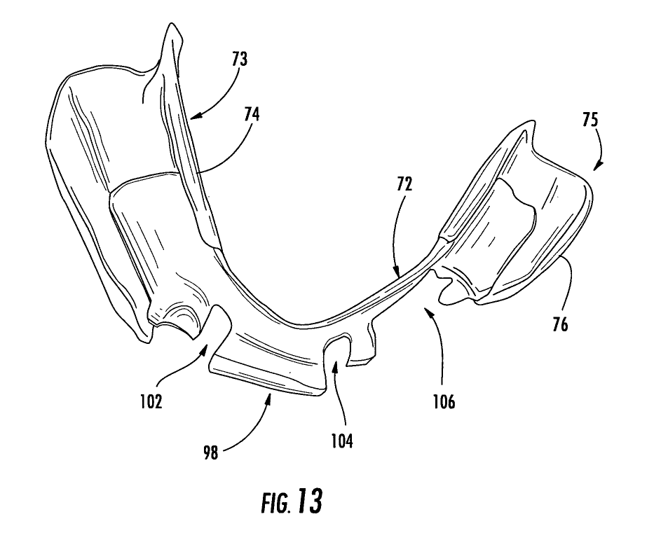

With reference now to FIG. 13, the bottom of the base 72 of denture 70 is preferably shaped in a manner that follows the shape of the gums of the jaw so that when the base 72 is positioned to lay on the gums, the base 72 snugly fits on the gums. Thus, the bottom portions of the base 72 adjacent to the first end 73 and second end 75 preferably has a U-shaped cross section. The cross section of the bottom of the base 72 at the central area 98 is preferably U-shaped, but is preferably much shallower than the U-shaped cross section of the bottom portions of the base adjacent to the first end 73 and second end 75.

Base 72 preferably forms recesses 102, 104, and 106. Recess 102 is preferably in between central area 98 and base portion adjacent to the first end 73. Recess 102 is preferably configured to accommodate the right cuspid (not shown). Recess 104 is preferably in between central area 98 and second extension 92, and is preferably configured to accommodate the left cuspid 84. Recess 106 is preferably in between second extension 92 and base portion adjacent to the second end 73. Recess 106 is preferably configured to accommodate the left first bicuspid 82 and left second bicuspid 80.

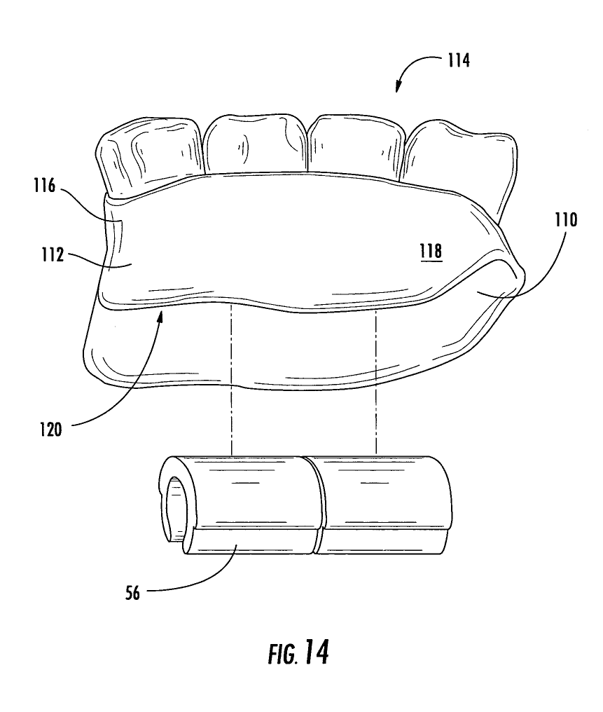

With reference now to FIG. 14, third artificial teeth assembly 78 preferably includes a plurality of artificial teeth 114, first artificial gum 110 and a second artificial gum 112. The plurality of artificial teeth 114 is preferably attached to the top of the first artificial gum 110. The top portion 116 of the second artificial gum 112 is preferably attached to the artificial teeth 114. The bottom portion 118 of the second artificial gum 112 is preferably attached to the first artificial gum 110. The first artificial gum 110 and the second artificial gum 112 preferably define a male fitting passage 120. Inside the male fitting passage 120 preferably lies a plurality of female fittings 56. The female fittings 56 are preferably made of similar material to the female fitting 56 discussed above and shown in FIG. 6.

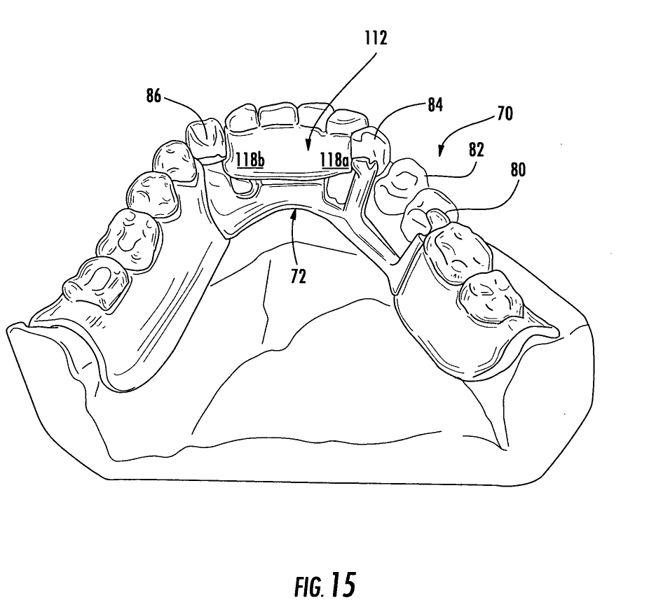

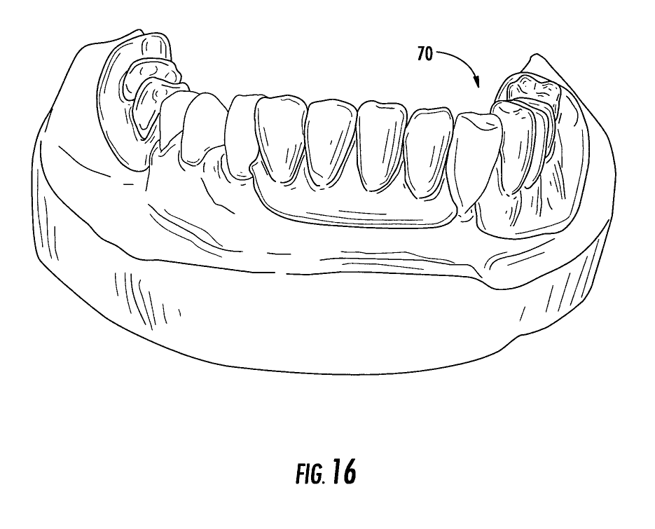

Referring to FIG. 15, the third artificial teeth assembly 78 preferably locks the base 72 to the jaw via the female fittings 56 (not shown) engaging to the male fitting 98 located in the central portion 88 of the base 72. It can be appreciated that bottom portions 118a and 118b of the second artificial gum 112 abuts the undercut area of left cuspid 84 and right cuspid 86, respectively, thereby locking the denture 70 in place. Referring to FIG. 16, it can be appreciated that denture 70 provides a denture that hides denture supporting structures, such as the base, from the front view of the user's mouth. Denture 70 thus provides a more aesthetically pleasing denture than prior art because it does not show any structures not usually associated with natural teeth, such as metal clasps. It can further be appreciated that the dentures of the present invention may form substantially continuous walls with the natural teeth of the user, which substantially prevent objects, such as food, from being retained in between the portions of the denture and the natural teeth.

Next, it can be appreciated that the dentures of the present invention provide a two-piece partial that substantially interlocks. The efficient interlocking of the base and the artificial teeth assembly may allow for the efficient chewing of food by the user. It may further minimize or prevent irritation and pain associated with loose dentures. Thus, the dentures of the present invention may provide dentures that are more comfortable to wear than conventional dentures.

Although the description above contains many specifications, these should not be construed as limiting the scope of the invention but as merely providing illustrations of some of presently preferred embodiments of this invention. For instance, the shapes of the base, the arrangements and numbers of the artificial teeth, and the placement of the fittings may vary depending on the structure of the remaining natural teeth of the user. Thus, the scope of the invention should be determined by the appended claims and their legal equivalents rather than by the examples given.

What is claimed is:

1. An artificial replacement for one or more teeth, the artificial replacement comprising:
(A) a base configured to be positioned on a natural gum and at least partially surround the natural gum;
(B) at least one artificial gum attachable to the base; the artificial gum comprising a retaining portion; and
(C) at least one artificial tooth attached to the artificial gum, wherein when the artificial gum is attached to the base, the retaining portion of the artificial gum abuts to an undercut of a natural tooth to substantially secure the base, the artificial gum, and the artificial tooth to the natural gum.

2. The artificial replacement for one or more teeth of claim 1, wherein the artificial gum is removeably attachable to the base.

3. The artificial replacement for one or more teeth of claim 1, further comprising:
(A) a male fitting connected to the base; and
(B) a female fitting attached to the artificial gum; the male and female fitting being configured to fasten to each other thereby allowing the artificial gum and the artificial tooth to attach to the base.

4. The artificial replacement for one or more teeth of claim 1, wherein the artificial gum is configured to substantially cover the base from a front view.

5. The artificial replacement for one or more teeth of claim 1, wherein when the artificial gum is attached to the base, the artificial gum and the natural tooth define a first wall.

6. The artificial replacement for one or more teeth of claim 5, wherein the artificial gum, the base, and a second natural tooth define a second wall.

7. The artificial replacement for one or more teeth of claim 5, wherein the artificial gum and a second natural tooth define a second wall.

8. An artificial replacement for one or more teeth, the artificial replacement comprising:
(A) a base configured to be positioned on a natural gum, the base comprising:
(a) two opposing slopes; and
(b) a ridge formed at the intersection of the opposing slopes, wherein the two opposing slopes and the ridge are configured to substantially surround the natural gum;
(B) at least one artificial gum removeably attachable to the base; and
(C) at least one artificial tooth attached to the artificial gum.

9. The artificial replacement for one or more teeth of claim 8, wherein the artificial gum comprises a retaining portion that is configured to abut to an undercut of a tooth.

10. The artificial replacement for one or more teeth of claim 8, further comprising:
(A) a male fitting connected to the base; and
(B) a female fitting attached to the artificial gum; the male and female fitting being configured to fasten to each other thereby allowing the artificial gum and the artificial tooth to attach to the base.

11. The artificial replacement for one or more teeth of claim 10, wherein the artificial gum is configured to cover a portion of the base from a front view.

12. The artificial replacement for one or more teeth of claim 8, wherein when the artificial gum is attached to the base, the artificial gum and the natural tooth define a first wall.

13. The artificial replacement for one or more teeth of claim 13, wherein the artificial gum, the base, and a second natural tooth define a second wall.

14. The artificial replacement for one or more teeth of claim 13, wherein the artificial gum and a second natural tooth define a second wall.

15. A method of making partial dentures, the method comprising:
(A) forming a base, the base being configured to be positioned on a natural gum; and
(B) forming at least one artificial gum and at least one artificial tooth, the artificial gum comprising a retaining portion, the retaining portion being configured to abut to an undercut area of a natural tooth when the artificial gum is attached to the base that is positioned on a natural gum, wherein the retaining portion is configured to substantially secure the artificial gum, the artificial tooth, and the base to the natural gum by abutting to the natural tooth.

16. The method of claim 15, further comprising:
(A) providing a male fitting to the base; and
(B) attaching a female fitting to the artificial gum, the female fitting being configured to removeably attach the artificial gum to the base by uniting with the male fitting of the base.

17. The method of claim 15, wherein the step of forming the base comprises:
(A) creating a model of a user's natural gum; and
(B) casting the base from the model.

18. The method of claim 17, further comprising modifying the model to cause the formation of a male fitting.

19. The method of claim 17, wherein the cast base comprises:
(A) a natural gum enclosure configured to substantially surround an alveolar ridge; and
(B) a male fitting attached to the natural gum enclosure, the male fitting being configured to receive a female fitting attached to the artificial gum, thereby attaching the artificial gum to the base.

20. The method of claim 17, wherein the cast base comprises at least one extension protruding perpendicular from the base, the extension being configured to abut to an undercut area of a natural tooth.

21. The method of claim 15, further comprising providing a plurality of artificial tooth assemblies, each of the tooth assembly comprising an artificial gum and at least one artificial tooth.

22. The method of claim 21, further comprising molding at least one artificial tooth assembly from the plurality of artificial tooth assemblies onto the base.

23. A denture comprising:
(A) a support means for supporting an artificial gum, the support means being configured to be positioned on a natural gum and at least partially surround the natural gum;
(B) at least one gum means for providing an artificial gum, the gum means being removeably attachable to the support means; the gum means comprising a retaining means for retaining the denture to a user's natural gum; and
(C) at least one tooth means for providing an artificial tooth, the tooth means being attached to the gum means, wherein when the gum means is attached to the support means, the retaining means abuts to an undercut of a natural tooth to substantially secure the support means, the gum means, and the tooth means to the user's natural gum.

24. The denture of claim 23, further comprising:
(A) a first fastener means for fastening the gum means to the support means, the first fastener means being connected to the base; and
(B) a second fastener means for fastening the gum means to the support means, the second fastener means being attached to the gum means; the first and second fastener means being configured to fasten to each other thereby allowing the gum means and the tooth means to attach to the support means.

25. A method for attaching a denture to a user, the method comprising:
(A) providing a base, the base comprising a natural gum enclosure configured to substantially surround the ridge of the natural gum;
(B) providing a male fitting connected to the base, the male fitting being configured to receive and fasten a female fitting connected to an artificial gum;
(C) providing an artificial gum, the artificial gum comprising a retaining portion configured to abut to an undercut area of a natural tooth; and
(D) allowing the male fitting to engage with the female fitting and the retaining portion to abut to the undercut area of the natural tooth.

26. The method of claim 25, wherein the step of allowing the male fitting to engage with the female fitting and the retaining portion to abut to the undercut area of the natural tooth comprises applying pressure on the artificial gum.

27. The method of claim 25, further comprising lifting the artificial gum at an area substantially proximate to the female fitting and allowing the artificial gum to detach from the base.

28. The method of claim 25, further comprising;
(A) positioning the artificial gum substantially proximate to the natural tooth; and
(B) tilting the artificial gum to substantially form an acute angle relative to the natural gum on which the artificial gum is configured to lay.
